(19) United States
(12) Patent Application Publication
(10) Pub. No.: US 2010/0323576 A1
(43) Pub. Date: Dec. 23, 2010

(54) Fabricating Method of Flexible Display Device

(76) Inventors: Po-Wen Hsiao, Hsinchu (TW); Yuan Chih Tsai, Hsinchu (TW); Lee-Tyng Chen, Hsinchu (TW); Ted-Hong Shinn, Hsinchu (TW)

Correspondence Address: LanWay IPR Services, P.O. Box 220746, Chantilly, VA, 20153, US

(21) Appl. No.: 12/556,654

(22) Filed: Sep. 10, 2009

(30) Foreign Application Priority Data
Jun. 18, 2009 (TW) 098120513

(51) Int. Cl. H01J 9/24

(52) U.S. Cl. 445/24

(57) ABSTRACT

In a fabricating method of flexible display device, firstly, a sacrificial layer is formed on a first rigid substrate. Secondly, a first flexible substrate is formed on the sacrificial layer. The bonding force of the sacrificial layer absorbing a breaking-bond light may be broken and the first flexible substrate is transparent for the breaking-bond light. Moreover, the transmission rate of visible light of the first flexible substrate is larger than that of the sacrificial layer. Then, the sacrificial layer is illuminated by the breaking-bond light for breaking the bonding force of the sacrificial layer to separate the first rigid substrate from the first flexible substrate. Since the first rigid substrate has a high transmission rate of visible light, may be separated from the first flexible substrate by the first breaking-bond light with low energy, the cost of fabricating the flexible display device may display the images with real color. Therefore, the chromatic performance of the flexible display device may be enhanced.

### BACKGROUND

This application claims priority to a Taiwan application No. 098120513 filed Jun. 18, 2009.

1. Field of the Invention

The invention relates to a method of fabricating display device, and more particularly, to a method of fabricating flexible display device.

2. Description of the Related Art

With progress of the flat display technique, more and more electrical products, especially portable electrical products such as mobile phones, e-books, digital cameras and personal digital assistants etc., are equipped with flat display apparatuses. The development trend of the portable electrical product is to achieve light weight and thin thickness, so the flat display apparatus for the portable electrical product should have these features.

It is well known that the flexible panel display not only has features of light weight and thin thickness, but also has features of flexibility and is not easy to be broken. Therefore, the development of the flexible panel display has become increasingly important. During the fabricating process of conventional flexible panel display, a controlling elements array and a color filter film are printed on plastic substrates respectively by roll-to-roll printing process first. Then, the substrates are assembled to each other.

However, the yield and the capacity of the roll-to-roll printing process are limited since the steadiness thereof is not good enough. Furthermore, the resolution of the controlling elements or the color filter film formed by the roll-to-roll printing process only achieve to about 30 micrometer. It is not corresponding to the tendency toward request the resolution of the nowadays display panel to 1 micrometer.

A conventional method for fabricating flexible display device is provided for increasing the solution of flexible display device. In the method, a flexible substrate is formed on a rigid substrate and a switch device array or color filter films is/are formed on the flexible substrate by semiconductor processes. Then, the flexible substrate is separated from the rigid substrate by using light illumination. Therefore, a flexible array substrate or a flexible color filter may be made.

However, since the color of the conventional flexible substrate which can be separated from the rigid substrate by light illumination is mostly approximate to yellow, a color shift phenomenon may be occurred as the light transmitting through the flexible substrate. Thus, the chromatic performance of the conventional flexible display panel is not good.

### BRIEF SUMMARY

The invention is directed to a fabricating method of flexible display device for fabricating a flexible display device having high solution and high chromatic performance with low cost.

The invention provides a fabricating method of flexible display device. Firstly, a sacrificial layer is formed on a first rigid substrate. Secondly, a first flexible substrate is formed on the sacrificial layer. A bonding force of the sacrificial layer is broken while a breaking-bond light is absorbed thereby. Moreover, the first flexible substrate is capable of being penetrated by the breaking-bond light and a transmission rate of visible-light thereof is larger than that of the sacrificial layer. Then, the sacrificial layer is illuminated by the breaking-bonding light to break the bonding force thereof. Therefore, the first flexible substrate is separated from the first rigid substrate.

According an embodiment of the invention, a plurality of color filter films are formed above the first flexible substrate before illuminating the sacrificial layer by the breaking-bonding light.

According an embodiment of the invention, an insulating layer is formed on the first flexible substrate before forming the color filter films. Afterward, the color filter films are formed on the insulating layer.

According an embodiment of the invention, a transparent electrode layer further formed on the color filter films.

According an embodiment of the invention, a display medium layer further formed on the transparent electrode layer.

According an embodiment of the invention, after forming the color filter films and before illuminating the sacrificial layer by the breaking-bonding light, the fabricating method further comprises the steps described in follow. Firstly, an array substrate is provided. Secondly, the first rigid substrate is assembled above the array substrate so as to make the color filter films face to the array substrate.

According an embodiment of the invention, a display medium layer is further formed on the array substrate before assembling the first rigid substrate above the array substrate.

According an embodiment of the invention, a transparent electrode layer is further formed on the display medium layer before assembling the first rigid substrate above the array substrate.

According an embodiment of the invention, the method of forming the array substrate comprises the steps of providing a second flexible substrate and forming a switch device array on the second flexible substrate.

According an embodiment of the invention, the second flexible substrate is formed on a second rigid substrate. After assembling the first rigid substrate above the array substrate, the second flexible substrate is further separated from the second rigid substrate.

According an embodiment of the invention, a switch device array is further formed on the first flexible substrate before illuminating the sacrificial layer by the breaking-bond light.

According an embodiment of the invention, a display medium layer is further formed on the switch device array and a color filter is assembled above the display medium layer before illuminating the sacrificial layer by the breaking-bond light.

According an embodiment of the invention, a display medium layer is further formed on a color filter and the color filter is assembled above the first rigid substrate so as to locate the display medium layer on the switch device array before illuminating the sacrificial layer by the breaking-bond light.

According an embodiment of the invention, the method of forming the color filter comprises the steps of forming a plurality of color filter films on a third flexible substrate and forming a transparent electrode layer on the color filter films.

According an embodiment of the invention, the third flexible substrate is formed on a third rigid substrate. After assembling the color filter above the display medium layer, the third flexible substrate is further separated from the third rigid substrate.

According an embodiment of the invention, at least a driving circuit is further formed on the first flexible substrate and electrically connected with the switch device array before illuminating the sacrificial layer by the breaking-bonding light.

According an embodiment of the invention, the sacrificial layer may be made of polyimide, amorphous silicon or poly-silicon.

According an embodiment of the invention, the first flexible substrate is made of polyimide, polyethylene terephthalate, polyethylene naphthalene, aromatic polyamide, polycycloolefin, polysulfone, epoxy resin, polycarbonate or polymethyl methacrylate.

In the flexible display device of the invention, since the first flexible substrate has high transmission ratio of visible light, the flexible display device fabricated by the invention may display images with real color and has improved chromatic performance.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A to FIG. 1G are schematic cross-section views of the flexible display device during manufacturing process according to an embodiment of the invention.

FIG. 2 is a schematic cross-section view of the flexible display device during partial manufacturing process according to another embodiment of the invention.

FIG. 3 is a schematic cross-section view of the flexible display device during partial manufacturing process according to another embodiment of the invention.

FIG. 4A to FIG. 4B are schematic cross-section views of the flexible display device during partial manufacturing process according to another embodiment of the invention.

### DETAILED DESCRIPTION

In the manufacturing process of flexible display device of the invention, a sacrificial layer is formed on a rigid substrate firstly, and then a flexible substrate is formed on the sacrificial layer. When the sacrificial layer absorbs the energy of a breaking-bonding light, the molecular bonds of the sacrificial layer is broken, and thus the sacrificial layer is evaporated. That is, the flexible substrate can be separated from the rigid substrate by illuminating the sacrificial layer by the breaking-bonding light.

The following description is given by way of example, and not limitation. The various features of the embodiments disclosed herein can be used alone, or in varying combinations with each other and are not intended to be limited to the specific combination described herein.

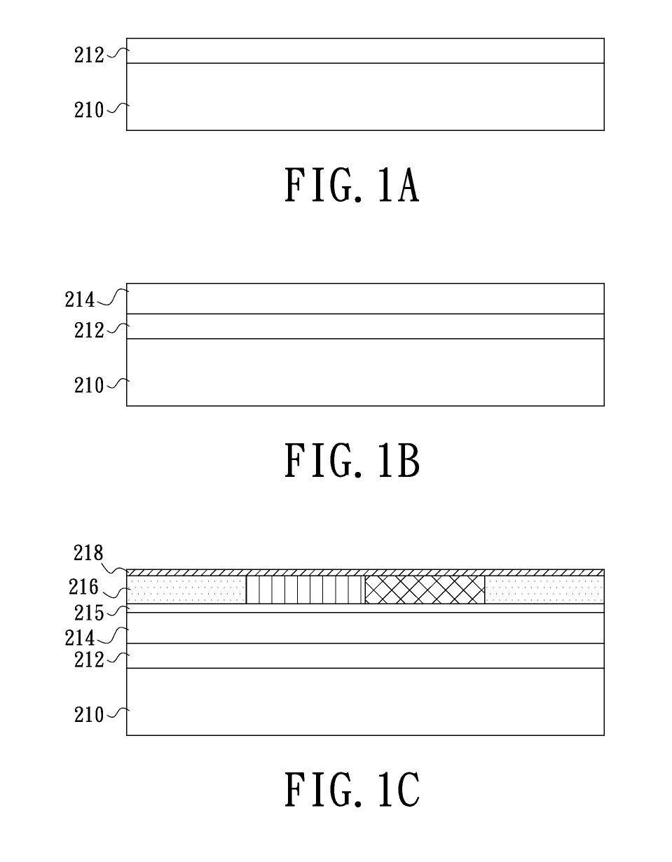

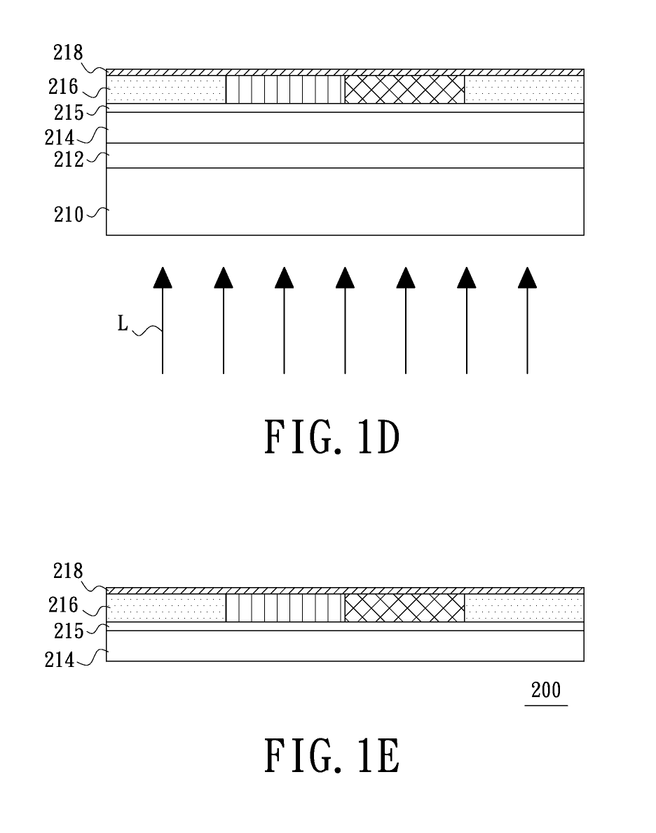

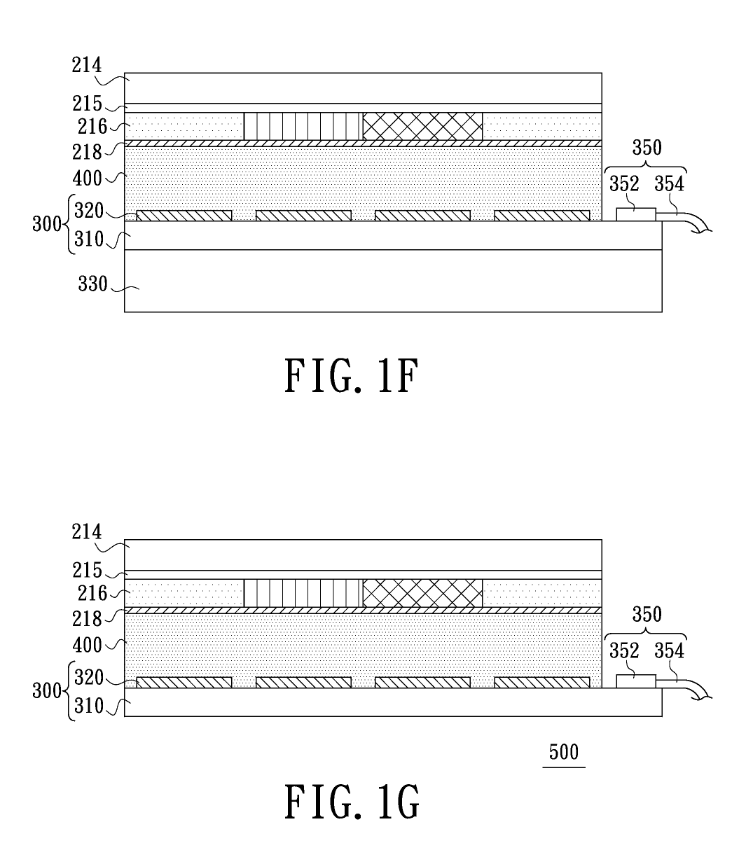

FIG. 1A to FIG. 1G are schematic cross-section view of the flexible display device during manufacturing process according to an embodiment of the invention. Referring to FIG. 1A, a sacrificial layer 212 is formed on a rigid substrate 210 first. In specific, the sacrificial layer 212 made of polyimide, amorphous silicon or poly-silicon would be evaporated as absorbing the energy of the breaking-bonding light. In this embodiment, the breaking-bonding light is, for example, UV-light. The thickness of the sacrificial layer 212 is, for example, between about 0.01 and 0.05 micro-meters.

Referring to FIG. 1B, after forming the sacrificial layer 212, a flexible substrate 214 made of polyimide, polyethylene terephthalate, polyethylene naphthalene, aromatic polyamide, polycycloolefin, polysulfone, epoxy resin, polycarbonate or polymethyl methacrylate is formed on the sacrificial layer 212. The flexible substrate 214 can be penetrated through by the breaking-bonding light, and the transmittance rate of visible light of the flexible substrate 214 is larger than that of the sacrificial layer 212. In detail, the flexible substrate 214 can be penetrated through by mostly visible light and thus being transparent completely. The sacrificial layer 212 is facile to absorb some visible light with a single color tone and thus being transparent but shifts to the single color tone.

Referring to FIG. 1C, in this embodiment, a insulating layer 215, a plurality of color filter films 216 and a transparent electrode layer 218 may be formed in sequence after forming the flexible substrate 214 on the sacrificial layer 212. Then, as shown in FIG. 1D, the sacrificial layer 212 is illuminated by the breaking-bonding light L for breaking the molecular bonds thereof, and thus the flexible substrate 214 is separated from the rigid substrate 210 to form a flexible color filter 200 as shown in FIG. 1E.

Referring to FIG. 1F, the color filter 200 is assembled above a pre-made array substrate 300. Specifically, in the process of fabricating the array substrate 300, a switch device array 320 is formed on a flexible substrate 310 first. In other words, the array substrate 300 is flexible as the color filter 200. The switch device array 320 may be active device array or passive device array. In this embodiment, the switch device array 320 is, for example, a thin film transistors array, but not limited hereto.

In addition, in this embodiment, a display medium layer 400 is formed on the array substrate 300 before assembling the color filter 200 above the array substrate 300. The display medium layer 400 may be electro-phoretic layer, electro-wetting layer or cholesteric liquid crystal layer. Furthermore, the transparent electrode layer 218 can also be formed on the display medium layer 400 besides being formed on the color filter films 216 during the manufacturing process of the color filter 200, but not limited hereto.

It is worth to say that the flexible substrate 310 can also be formed on a rigid substrate 330 before forming the switch device array 320 on the flexible substrate 310 during the manufacturing process of the array substrate 300. Moreover, the flexible substrate 310 is separated from the rigid substrate 330 after assembling the color filter 200 above the array substrate 300 in this embodiment, as shown in FIG. 1G. Therefore, the manufacturing process of the flexible display device 500 is substantially finished.

Referring to FIG. 1F again, a driving circuit 350 electrically connected with the switch device array 320 is formed on the flexible substrate 310 before separating the flexible substrate 310 from the rigid substrate 330. Thus, the precision of the process of forming the driving circuit 350 can be increased. In specific, the driving circuit 350 includes, for example, a driving chip 352 and a flexible printed circuit board 354 electrically connected to the external circuit (not shown).

According to the above description, the sacrificial layer 212 is formed between the rigid substrate 210 and the flexible substrate 214. Additionally, the breaking-bonding light with low energy can be used for illuminating the sacrificial layer 212 to separate the flexible substrate 214 from the rigid substrate 210. Therefore, the cost of manufacturing process of the flexible display device 500 may be decreased. Furthermore, since the transmittance rate of visible light of the flexible substrate 214 is high than that of convention, the flexible display device 500 may has improved chromatic performance.

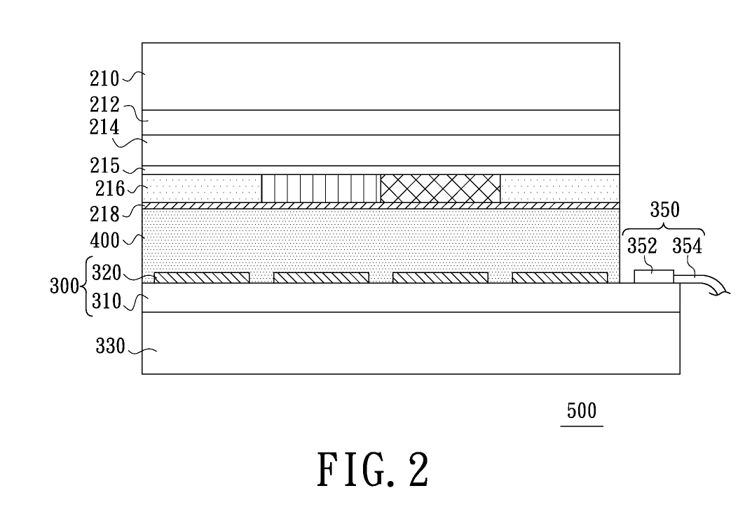

It should be noted that in another embodiment of the invention, the rigid substrate 210 and the structures formed thereon may be assembled above the array substrate 300 and thus the transparent electrode layer 218 is located on the display medium layer 400 before separating the flexible substrate 214 from the rigid substrate 210, as shown in FIG. 2. Then, the flexible substrate 214 and the flexible substrate 310 are separated from the rigid substrate 210 and the rigid substrate 330 respectively. Therefore, the flexible display device 500 shown in FIG. 1G is made.

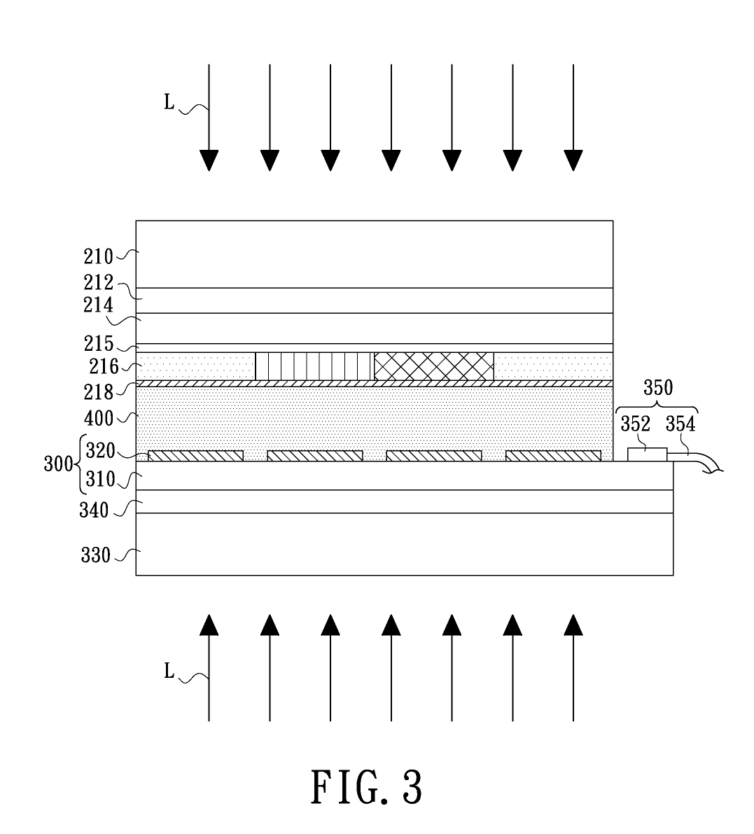

Specially, in another embodiment of the invention, a sacrificial layer 340 can be formed on the rigid substrate 330 before forming the flexible substrate 310 on the rigid substrate 330, and then the flexible substrate 310 is formed on the sacrificial layer 340, as shown in FIG. 3. The sacrificial layer 340 is the same with the sacrificial layer 212 formed on the rigid substrate 210. Therefore, the sacrificial layer 212 and the sacrificial layer 340 can be illuminated by the breaking-bonding light L during the same process, and then the flexible substrate 214 and the flexible substrate 310 can be separated from the rigid substrate 210 and the rigid substrate 330 respectively, such that the flexible display device 500 shown in FIG. 1G may be made.

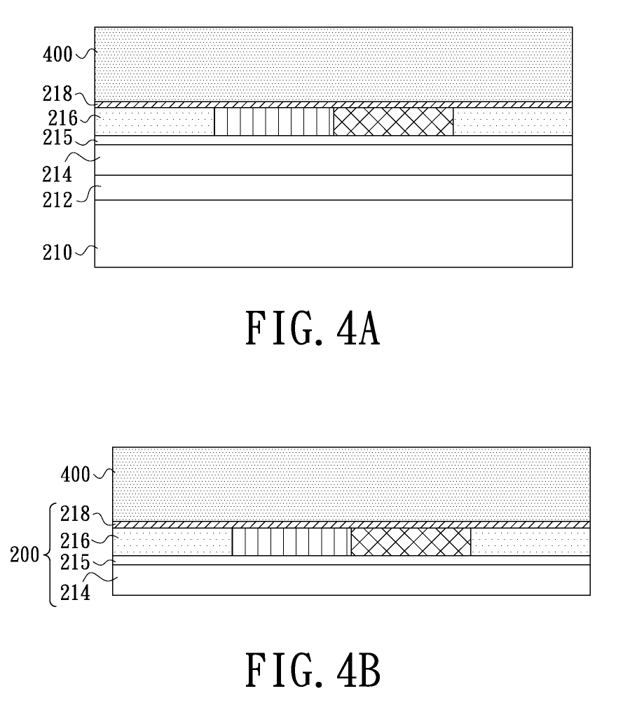

In spite of the display medium layer 400 is formed on the array substrate 300 before assembling the color filter 200 above the array substrate 300 in the aforementioned embodiments, but it is not limited hereto. In another embodiment of the invention, the display medium layer 400 is formed on the color filter films 216, as shown in FIG. 4A. Then, the sacrificial layer 212 is illuminated by the breaking-bonding light, and thus the flexible substrate 214 is separated from the rigid substrate 210. Additionally, the color filter 200 is made, as shown in FIG. 4B. After that, the color filter 200 formed with the display medium layer 400 is assembled above the array substrate 300 to form the structure shown in FIG. 1F. Later, the flexible substrate 310 is separated from the rigid substrate 330. Thus, the flexible display device 500 shown in FIG. 1G is made. The method for separating the flexible substrate 310 from the rigid substrate 330 is described in above paragraphs, it is unnecessary to say here.

It should be noted that although the display medium layer 400 is formed on the color filter films 216 before separating the flexible substrate 214 from the rigid substrate 210 in this embodiment, but the invention is not limited hereto. One skilled in the art could decide if forming the display medium layer 400 on the color filter films 216 before separating the flexible substrate 214 from the rigid substrate 210 according to the process conditions in actual.

In summary, in the manufacturing process of the flexible display device of the invention, the sacrificial layer is formed on the rigid substrate first, and then the flexible substrate is formed on the sacrificial layer. After that, the internal devices of the display are formed on the flexible substrate. Since the rigid substrate can sustain the flexible substrate during the manufacturing process of the flexible display device, the elements may be formed on the flexible substrate by semiconductor process. Therefore, the precision of the manufacturing process of the flexible display device and the solution of the flexible display device may be increased.

Moreover, since the light used for breaking the molecular bonds of the sacrificial layer has the advantages of low energy and long wavelength, compare to convention, the invention can use the apparatus with lower cost to separate the flexible substrate from the rigid substrate. Therefore, the cost of manufacturing process of the flexible display device may be decreased.

In addition, since the transmittance rate of visible light of the flexible substrate of the invention is higher than that of conventional flexible substrate, the flexible display device fabricated according to the invention may display the images with real color. Thus, the chromatic performance of the flexible display device may be improved.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A fabricating method of flexible display device, comprising the steps of:
forming a sacrificial layer on a first rigid substrate, wherein a bonding force of the sacrificial layer is broken while a breaking-bond light is absorbed thereby;
forming a first flexible substrate on the sacrificial layer, wherein the first flexible substrate is capable of being penetrated by the breaking-bond light, a transmission rate of visible-light thereof is larger than that of the sacrificial layer; and
illuminating the sacrificial layer by the breaking-bond light for breaking the bonding force of the sacrificial layer to separate the first rigid substrate from the first flexible substrate.

2. The method as claimed in claim 1, further comprising the step of forming a plurality of color filter films above the first flexible substrate before illuminating the sacrificial layer by the breaking-bond light.

3. The method as claimed in claim 2, further comprising the step of forming an insulating layer on the first flexible substrate before forming the color filter films, wherein afterward the color filter films are formed on the insulating layer.

4. The method as claimed in claim 2, further comprising the step of forming a transparent electrode layer on the color filter films.

5. The method as claimed in claim 4, further comprising the step of forming a display medium layer on the transparent electrode layer.

6. The method as claimed in claim 2, further comprising the steps after forming the color filter films and before illuminating the sacrificial layer by the breaking-bond light:
providing an array substrate; and
assembling the first rigid substrate above the array substrate so as to make the color filter films face to the array substrate.

7. The method as claimed in claim 6, further comprising the step of forming a display medium layer on the array substrate before assembling the first rigid substrate above the array substrate.

8. The method as claimed in claim 7, further comprising the step of forming a transparent electrode layer on the display medium layer before assembling the first rigid substrate above the array substrate.

9. The method as claimed in claim 6, wherein the method for forming the array substrate comprises the steps of:
providing a second flexible substrate; and
forming a switch device array on the second flexible substrate.

10. The method as claimed in claim 9, wherein the second flexible substrate is formed on a second rigid substrate, the method further comprising separating the second flexible substrate from the second rigid substrate after assembling the first rigid substrate above the array substrate.

11. The method as claimed in claim 1, further comprising the step of forming a switch device array on the first flexible substrate before illuminating the sacrificial layer by the breaking-bond light.

12. The method as claimed in claim 11, further comprising the steps before illuminating the sacrificial layer by the breaking-bond light:
forming a display medium layer on the switch device array;
providing a color filter substrate; and
assembling the color filter above the display medium layer.

13. The method as claimed in claim 12, wherein the method for forming the color filter comprises the steps of:
providing a third flexible substrate;
forming a plurality of color filter films above the third flexible substrate; and
forming a transparent electrode layer on the color filter films.

14. The method as claimed in claim 13, wherein the third flexible substrate is formed on a third rigid substrate, the method further comprises the step of separating the third flexible substrate from the third rigid substrate after assembling the color filter above the display medium layer.

15. The method as claimed in claim 11, further comprising the steps before illuminating the sacrificial layer by the breaking-bonding light:
providing a color filter substrate;
forming a display medium layer on the color filter substrate; and
assembling the color filter above the first rigid substrate so as to make the display medium layer locate on the switch device array.

16. The method as claimed in claim 15, wherein the method for forming the color filter comprises the steps of:
providing a third flexible substrate;
forming a plurality of color filter films on the third flexible substrate; and
forming a transparent electrode layer on the color filter films.

17. The method as claimed in claim 16, wherein the third flexible substrate is formed on a third rigid substrate, the method further comprises the step of separating the third flexible substrate from the third rigid substrate after assembling the color filter above the first rigid substrate.

18. The method as claimed in claim 11, further comprising the step of forming at least a driving circuit electrically connected with the switch device array on the first flexible substrate before illuminating the sacrificial layer by the breaking-bonding light.

19. The method as claimed in claim 1, wherein the sacrificial layer is made of polyimide, amorphous silicon or poly-silicon.

20. The method as claimed in claim 1, wherein the first flexible substrate is made of polyimide, polyethylene terephthalate, polyethylene naphthalene, aromatic polyamide, polycycloolefin, polysulfone, epoxy resin, polycarbonate or polymethyl methacrylate.
